(19) United States
(12) Patent Application Publication
(10) Pub. No.: US 2023/0000070 A1
(43) Pub. Date: Jan. 5, 2023

(54) DEPLOYABLE DECOY SYSTEM FOR THE ATTRACTION OF WILD GAME AND METHODS FOR MANUFACTURING AND DEPLOYING THE SAME

(71) Applicant: CRÉAVAL INC., Repentigny (CA)

(72) Inventor: Guy Charron, Repentigny (CA)

(21) Appl. No.: 17/782,089

(22) PCT Filed: Dec. 18, 2020
(86) PCT No.: PCT/CA2020/051764

§ 371 Date: Jun. 2, 2022

Related U.S. Application Data
(60) Provisional application No. 62/951,779, filed on Dec. 20, 2019.

(51) Int. Cl. A01M 31/06

(52) U.S. Cl. CPC A01M 31/06

(57) ABSTRACT

A foldable decoy panel that is adapted to be folded to form a wild game body of a deployable decoy system, as well as a corresponding kit, a corresponding deployable decoy system, and corresponding manufacturing and deploying methods. The foldable decoy panel includes: a central portion; and a plurality of peripheral flaps pivotally mounted to the central portion and pivotable about fold lines acting as hinges to configure the decoy panel in a deployed three-dimensional configuration forming a decoy hollow body representing the wild game body.

### PRIOR APPLICATION

The present application claims priority from U.S. provisional patent application No. 62/951,779, filed on Dec. 20, 2019, and entitled “DEPLOYABLE DECOY SYSTEM FOR THE ATTRACTION OF WILD GAME AND METHOD FOR DEPLOYING THE SAME”, the disclosure of which being hereby incorporated by reference in its entirety.

### TECHNICAL FIELD

The present disclosure relates to hunting equipment and accessories. More particularly, the present disclosure relates to deployable decoy systems for the attraction of wild game and to methods for deploying and manufacturing the same.

### BACKGROUND

There exists in the art a plurality of decoy devices and systems to attract wild game, such as wild fowl game species, wild waterfowl game species, and the like.

Some of them are made of a material that can allow the decoy device to float, so they can be used into water. Such floatable decoy devices are usually provided as a single piece, three-dimensional decoy device, which can be troublesome when it is time to transport and/or to store the plurality of decoy devices.

There also exists on the market deployable or foldable decoy devices and/or inflatable decoy devices that can easily be stored and/or transported. The final deployed decoy device however rarely realistically represents the wild game species body and/or head. For example, they can be two-dimensional and/or static (all the deployed decoy devices represent the same wild game, identically positioned, etc.) The available deployable decoy devices are also usually difficult to deploy and/or non-resistant once on field or into water.

Examples of published patents references are as follow: US patent publication no. 20170280705, US patent publication no. 2016,0235053, U.S. Pat. No. 4,251,937, Canadian patent no. 1,157,266, U.S. Pat. Nos. 9,801,368, 4,689,913, 6,216,382, 6,385,895, 9,402,386, 7,481,017, 4,753,028, Canadian patent no. 1,280,596, U.S. Pat. Nos. 7,788,839, 10,034,474, 9,961,893, and 9,693,550.

Therefore, there remains a need for improved deployable decoy systems for the attraction of wild game that provide a realistic representation of the wild game species, that can easily and quickly be deployed, while being convenient to transport and/or to store, and which, by virtue of their designs and components, would be able to overcome or at least minimize some of the above-discussed concerns.

### SUMMARY

It is an object of the present disclosure to provide deployable decoy systems that overcome or mitigate one or more disadvantages of known decoy devices and systems, or at least provide useful alternatives.

In accordance with a first general aspect, there is provided a foldable decoy panel for a deployable decoy system for the attraction of wild game, the foldable decoy panel comprising a decoy main section; and a plurality of decoy extensions extending from the decoy main section, each of said plurality of decoy extensions comprising a proximal edge being part of or being mounted to the decoy main section and a distal edge extending in a spaced relationship to the proximal edge, each of said plurality of decoy extensions being foldable with respect to the decoy main section to configure the decoy panel in a deployed three-dimensional configuration forming a decoy hollow body representing a wild game body.

In accordance with another general aspect, there is provided a foldable decoy panel that is adapted to be folded to form a wild game body of a deployable decoy system, the foldable decoy panel comprising: a central portion; and a plurality of peripheral flaps pivotally mounted to the central portion and pivotable about fold lines acting as hinges to configure the decoy panel in a deployed three-dimensional configuration forming a decoy hollow body representing the wild game body.

In accordance with another general aspect, there is provided a deployable decoy system, comprising a foldable decoy panel according to the present disclosure; and a plurality of elongated member-receiving clips, each of said plurality of elongated member-receiving clips comprising a panel-mounting end portion mounted to a corresponding one of the plurality of decoy extensions and a distal end portion forming an elongated member-receiving channel.

According to another general aspect, there is provided a decoy kit for forming at least one deployable decoy system, the kit comprising at least one foldable decoy panel according to the present disclosure; and one or more interchangeable decoy three-dimensional heads mountable to said at least one of foldable decoy panel.

According to another general aspect, there is provided a method for manufacturing a foldable decoy panel, comprising providing a sheet of material comprising first and second opposed surfaces; forming a pattern on at least one of the first and second opposed surfaces; and die cutting into the sheet of material a decoy main section and a plurality of decoy extensions extending from the decoy main section, each decoy extension being foldable with respect to the main section.

According to another general aspect, there is provided a method for deploying a decoy system for the attraction of wild game, the method comprising providing a foldable decoy panel according to the present disclosure; inserting an assembling elongated member in the plurality of elongated member-receiving channels; and pulling opposed ends of the assembling elongated member to force each of said plurality of decoy extensions to be brought closed to adjacent decoy extensions.

In accordance with another embodiment, there is provided a deployable decoy system for the attraction of wild game, the deployable decoy system comprising: a decoy panel being configured to be deployed between a two-dimensional configuration and a deployed three-dimensional configuration forming a decoy hollow body representing a wild game body, the decoy panel comprising: a decoy main section; a plurality of spaced apart decoy extensions extending from the decoy main section, each one of the plurality of spaced apart decoy extensions defining a distal edge; and a head mounting aperture formed in the decoy main section; a plurality of channels formed at the distal edges; a decoy three-dimensional head representing a wild game head and defining a securing end being securable to the head mounting aperture; and an elongated attachment member insertable in the plurality of channels and being configured to be pulled so as to force each one of the plurality of spaced apart decoy extensions to interface with adjacent ones of the plurality of spaced apart decoy extensions, thereby forming the decoy hollow body.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of a deployable decoy system in accordance with an embodiment, the deployable decoy system comprising a foldable decoy panel, a decoy three-dimensional head, an anchoring member and an assembling elongated member configuring the foldable decoy panel in a deployed three-dimensional configuration;

FIG. 2 is a plan view of the foldable decoy panel of FIG. 1, the decoy panel being configured in a two-dimensional configuration;

FIG. 3 is a bottom plan view of the foldable decoy panel and the assembling elongated member of FIG. 1;

FIG. 4 is a cross-sectional view of a portion of a blank panel in accordance with an embodiment, in which is formed the foldable decoy panel of FIG. 1;

FIG. 5A is a perspective view of a distal edge of a decoy extension in accordance with an embodiment, where a single elongated member-receiving channel is being formed so as to receive the assembling elongated member therein, and where the channel is being formed by folding an end section of the decoy extension and by securing it thereon;

FIG. 5B is a perspective view of a distal edge of a decoy extension in accordance with another embodiment, where two channel sections are being formed at opposed ends of the distal edge so as to receive the assembling elongated member therein, and where the channel sections are being formed by folding end sections of the decoy extension and by securing it thereon;

FIG. 5C is a cross-sectional view of the distal edge the decoy extension of FIG. 5A;

FIG. 5D is a cross-sectional view of a distal edge of a decoy extension in accordance with another embodiment;

FIG. 6A is a perspective view of a distal edge of a decoy extension in accordance with another embodiment, where a single channel is being formed by folding an end section of the decoy extension so as to insert a tube-like member therein to receive the assembling elongated member;

FIG. 6B is a perspective view of a distal edge of a decoy extension in accordance with another embodiment, where two channel sections are being formed at opposed ends of the distal edge by folding end sections of the decoy extension and by securing it thereon so as to insert a tube-like member therein to receive the assembling elongated member;

FIG. 6C is a cross-sectional view of the distal edge the decoy extension of FIG. 6A;

FIG. 6D is a cross-sectional view of a distal edge of a decoy extension in accordance with another embodiment;

FIG. 7A is a perspective view of a distal edge of a decoy extension in accordance with another embodiment, where an elongated member-receiving clip comprising a single channel is being secured to the distal edge to receive the assembling elongated member therein;

FIG. 7B is a perspective view of a distal edge of a decoy extension of the foldable decoy panel of FIG. 1, where elongated member-receiving clips comprising a channel are being secured to the distal edge at opposed ends thereof to receive the assembling elongated member therein;

FIG. 7C is a side elevation view of an elongated member-receiving clip being secured to a distal edge of a decoy extension in accordance with another embodiment;

FIG. 7D is a side elevation view of an elongated member-receiving clip being secured to a distal edge of a decoy extension in accordance with another embodiment;

FIG. 7E is a side elevation view of an elongated member-receiving clip being secured to a distal edge of a decoy extension in accordance with another embodiment, the clip comprising a clip body and a panel-mounting rivet;

FIG. 8 is a side elevation view of an elongated member-receiving channel formed at a distal edge of a decoy extension in accordance with yet another embodiment;

FIG. 9 is a perspective view of a decoy three-dimensional head in accordance with an embodiment;

FIG. 10 is a perspective view of a decoy three-dimensional head in accordance with another embodiment;

FIG. 11 is a perspective view of a decoy three-dimensional head in accordance with another embodiment;

FIG. 12 is a perspective view of a decoy three-dimensional head in accordance with another embodiment;

FIG. 13 is a perspective view of a deployable decoy system in accordance with another embodiment, the deployable decoy system comprising the decoy three-dimensional head of FIG. 12 and a foldable decoy panel being shown in its deployed three-dimensional configuration;

FIG. 14 is a plan view of the foldable decoy panel of FIG. 13, the decoy panel being shown in its two-dimensional configuration;

FIG. 15 is a perspective view of the deployable decoy system of FIG. 1, partially sectioned, further comprising decoy legs mounted to the decoy panel;

FIG. 15A is an enlarged view of the securing of the anchoring member to the foldable decoy panel;

FIG. 16 is a perspective view of the clip body of FIG. 7E;

FIG. 17 is a perspective view, exploded, of the panel-mounting rivet of FIG. 7E;

FIG. 18 is a block diagram representing the different steps of a method for manufacturing a foldable decoy panel in accordance with an embodiment; and

FIG. 19 is a block diagram representing the different steps of a method for deploying a decoy system in accordance with an embodiment.

### DETAILED DESCRIPTION

In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures or described in the present disclosure are embodiments only, given solely for exemplification purposes.

Furthermore, in the context of the present description, it will be considered that all elongated objects will have an implicit “longitudinal axis” or “centerline”, such as the longitudinal axis of a shaft for example, or the centerline of a biasing device such as a coiled spring, for example, and that expressions such as “connected” and “connectable”, “secured” and “securable”, “engaged” and “engageable”, “installed” and “installable” or “mounted” and “mountable”, may be interchangeable, in that the present deployable decoy system also relates to a kit with corresponding components for assembling a resulting fully-assembled and fully-operational deployable decoy system.

Moreover, components of the deployable decoy system and/or steps of the method(s) described herein could be modified, simplified, altered, omitted and/or interchanged, without departing from the scope of the present disclosure, depending on the particular applications which the present deployable decoy system is intended for, and the desired end results, as briefly exemplified herein and as also apparent to a person skilled in the art.

In addition, although the embodiments as illustrated in the accompanying drawings comprise various components, and although the embodiments of the present deployable decoy system and corresponding portion(s)/part(s)/component(s) as shown consist of certain geometrical configurations, as explained and illustrated herein, not all of these components and geometries are essential and thus should not be taken in their restrictive sense, i.e. should not be taken so as to limit the scope of the present disclosure. It is to be understood, as also apparent to a person skilled in the art, that other suitable components and cooperation thereinbetween, as well as other suitable geometrical configurations may be used for the present deployable decoy system and corresponding portion(s)/part(s)/component(s) according to the deployable decoy system, as will be briefly explained herein and as can be easily inferred herefrom by a person skilled in the art, without departing from the scope of the present disclosure.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

The present disclosure describes deployable decoy systems for the attraction of wild game that provide a realistic representation of the wild game species, that can easily and quickly be deployed, while being convenient to transport and/or to store, and which, by virtue of their designs and components, would be able to overcome or at least minimize some of the above-discussed concerns.

According to the present disclosure, a person skilled in the art to which the deployable decoy system pertains would understand that wild game can include wild land mammals which are hunted (including wild mammals living within an enclosed area under conditions of freedom similar to those enjoyed by wild game) and wild birds.

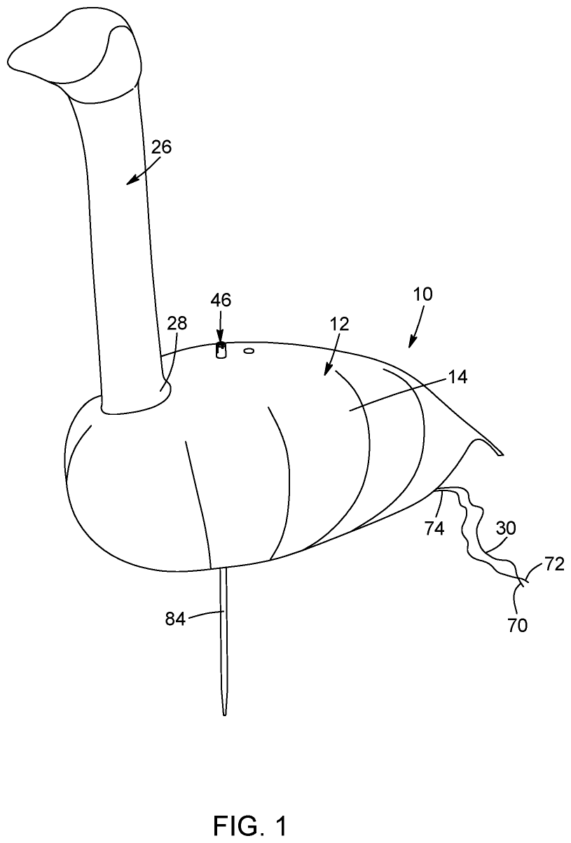

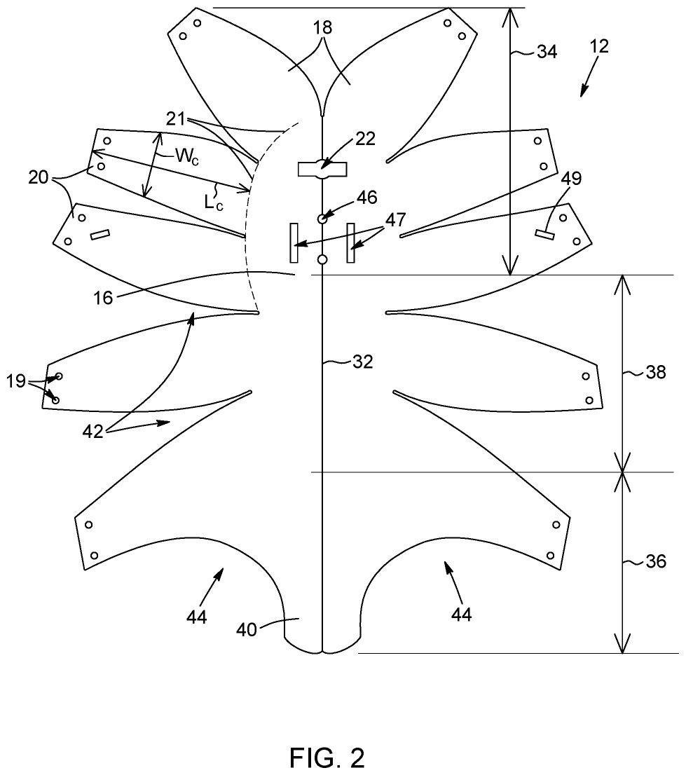

Referring now to the drawings and more particularly to FIGS. 1 to 3, there is shown a deployable decoy system 10 that can be deployed for the attraction of wild game, in accordance with a non-limitative embodiment. The deployable decoy system 10 includes a foldable decoy panel 12 which is configured to be deployed and/or configured between a substantially two-dimensional compact configuration (FIG. 2) and a deployed three-dimensional configuration (FIGS. 1 and 3) forming a decoy hollow body 14 which represents a wild game body, as it will be described in more details herein.

As detailed below, the foldable decoy panel 12 comprises a decoy main section 16 (or decoy substantially central portion 16 or central portion 16) and a plurality of decoy extensions 18 (or peripheral flaps 18) extending from the decoy main section 16, each of the plurality of decoy extensions 18 comprising a proximal edge 21 being part of or being mounted to the decoy main section 16 and a distal edge 20 extending in a spaced relationship to the proximal edge 21. Each decoy extension 18 is foldable with respect to the decoy main section 16 to configure the foldable decoy panel 12 in the deployed three-dimensional configuration forming the decoy hollow body 14 representing the wild game body.

In other words, the foldable decoy panel 12 is adapted to be folded to form the wild game body of the deployable decoy system 10. The foldable decoy panel 12 comprises the main (or substantially central) portion 16 and a plurality of peripheral flaps 18 (or decoy extensions 18) pivotally mounted to the central portion 16 and pivotable about fold lines acting as hinges to configure the decoy panel 12 in the deployed three-dimensional configuration forming the decoy hollow body 14 representing the wild game body.

As best shown in FIG. 2, the plurality of spaced apart decoy extensions 18 (or peripheral flaps 18) extend away from the decoy main section 16.

In the embodiment shown, at least one of the plurality of decoy extensions 18 has a substantially rectangular shape and defines an extension length Le extending between the proximal and distal edges 21, 20, and an extension width We, the extension width We being smaller than or substantially equal to the extension length Le. For instance, the extension width We is smaller than about 90% of the extension length Le. In another embodiment, the extension width We is smaller than about 75% of the extension length Le. In another embodiment, the extension width We is smaller than about 50% of the extension length Le. In yet another embodiment, the extension width We is smaller than about 25% of the extension length Le.

In the embodiment shown, as represented for instance in FIG. 2, the decoy panel 12 extends between an anterior section 34 and a posterior section 36 and has a plane of symmetry extending between the anterior and posterior sections 34, 36 and defining a centered line 32 of the decoy main section 16.

The decoy panel 12 further includes a head mounting aperture 22 formed therein, for instance formed in the decoy main section 16.

As detailed below, the deployable decoy system 10 further comprises a plurality of elongated member-receiving channels 24 mounted to or part of the plurality of decoy extensions 18 (for instance mounted to or part of the distal edges 20 thereof). As detailed below, an assembling elongated member 30 is insertable in the plurality of elongated member-receiving channels 24 to configure the decoy panel 12 in the deployed three-dimensional configuration upon pulling of the assembling elongated member 30 (for instance upon pulling of at least one of the end portions thereof).

Still referring to the non-limitative embodiment of FIGS. 1 to 3, the deployable decoy system 10 further includes a decoy three-dimensional head 26 which represents a wild game head mountable (for instance removably) to the decoy hollow body 14. The decoy three-dimensional head 26 defines a securing end 28 (or body-mounting end 28), which is securable, for instance removably, to the head mounting aperture 22 formed in the decoy panel 12.

The deployable decoy system 10 further includes the assembling attachment member 30 (or elongated attachment member 30) (FIGS. 1 and 3), which is configured to be inserted in the plurality of elongated member-receiving channels 24, as it will be described in more details below.

The assembling elongated member 30 is configured to be pulled so as to force each decoy extension 18 to interface with, or to be brought closed to, its adjacent decoy extension(s) 18, thereby forming the decoy hollow body 14 shown in FIGS. 1 and 3.

Referring now more particularly to FIG. 2, in some implementations, the decoy panel 12 includes ten spaced apart decoy extensions 18, or sleeves 18, or peripheral flaps 18, where each decoy extension 18 extends from the decoy main section 16. The above-mentioned posterior section 36 of the decoy panel 12 includes a tail portion 40. A central section 38 further separates (i.e. extends between) the anterior section 34 from the posterior section 36. As illustrated in the non-limitative embodiment of FIG. 2, two adjacent decoy extensions 18 are spaced apart from each other by a V-shaped void 42. However, in the posterior section 36, the decoy extensions 18 that are adjacent to the tail portion 40 are spaced apart from the tail portion 40 by a C-shape void 44. In other words, in the embodiment shown, adjacent decoy extensions 18 define one of V-shaped and C-shaped voids therebetween. A person skilled in the art to which deployable decoy system 10 pertains would however understand that the decoy panel 12 can take any shape, size and/or configurations, and include the needed number of decoy extensions with the needed shape of the voids therebetween, so as to form the decoy hollow body 14 which would represent the body of a specific wild game.

In the following description, the terms anterior and posterior will equally refer to the decoy panel and the decoy main section thereof.

Still referring to the non-limitative embodiment of FIG. 2, the head mounting aperture 22 is provided in the anterior section 34 of the decoy main section 16. Furthermore, the tail portion 40 is longitudinally aligned with the head mounting aperture 22 (i.e. both the head mounting aperture 22 and the tail portion 40 are provided substantially about the centered line 32). In the embodiment shown, the above-mentioned centered line 32 at least partially intersects the head-mounting aperture 22.

Still referring to the non-limitative embodiment of FIGS. 1 to 3, the foldable decoy panel 12 can further include a ground-mounting aperture 46 (or stake-mounting aperture 46) formed in the decoy main section 16. For instance, the stake-mounting aperture 46 is formed in the decoy main section 16 in alignment with the centered line 32, for instance in the anterior section 34 thereof. An upper end of a stake or anchoring member 84 can therefore be secured to the ground-mounting aperture 46 so as to allow land mounting of the deployable decoy system 10.

In some implementations, the decoy panel 12 can further include wing mounting apertures 47 and/or leg mounting apertures 49 for securing wings and/or legs which represent wild game wings and/or legs. For instance, at least one of the wing-mounting apertures 47 and leg-mounting apertures 49 is formed in at least one of the plurality of decoy extensions 18.

As mentioned above, the decoy panel 12 is deployable, or foldable, or configurable, between the two-dimensional configuration shown in FIG. 2 and the deployed three-dimensional configuration shown in FIGS. 1 and 3, so as to form the decoy hollow body 14. The deployed three-dimensional configuration can therefore represent a body of a particular wild game species. In some implementations and as well illustrated in FIGS. 1 to 3, the decoy panel 12 provided in or configured into its deployed three-dimensional configuration can realistically represent a particular wild waterfowl game species.

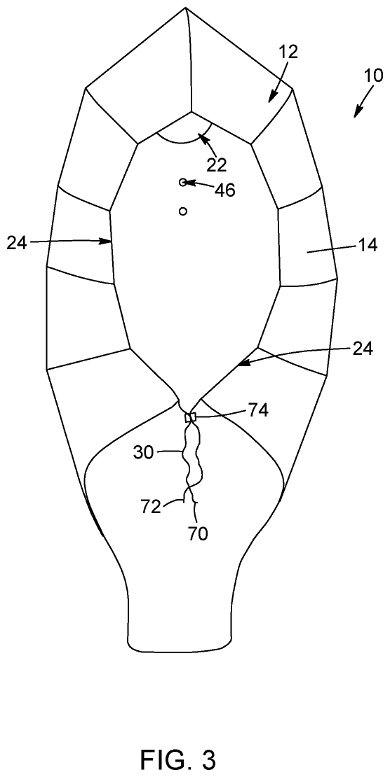

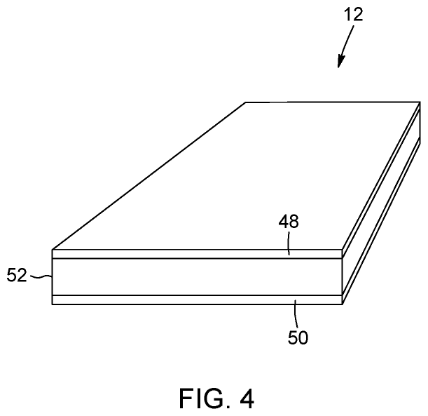

Now referring more particularly to the non-limitative embodiment of FIG. 4, in some implementations, the foldable deploy panel 12 can be made from a blank panel. In some implementations, the blank panel can be made from a lightweight, flexible, and/or semi-rigid material. The decoy panel 12 can be formed from, or die cut into, a substantially planar and foldable blank panel. As illustrated in the non-limitative embodiment of FIG. 4, the decoy panel 12 defines a top (or outer or first) surface 48 and a bottom (or inner or second) surface 50, which is found opposite to the top surface 48. The decoy panel 12 further includes a sidewall 52 which joins the top and bottom surfaces 48, 50 (or first and second surfaces 48, 50) together.

In some implementations, at least one of the first and second surfaces 48, 50 comprises at least one marking thereon so as to represent a specific wild game species. In some implementations, only one of the top and bottom surfaces 48, 50 (or first and second surfaces 48, 50) of the decoy panel 12 can be adorned with markings and colors so as to represent a specific wild game species (e.g. one of a fowl or a bird species, one of a male or a female species, etc.). In some other implementations, the first and second surfaces 48, 50 comprise different markings thereon, so that the foldable decoy panel 12 can be used reversibly. In other words, the top surface 48 of the decoy panel 12 can be adorned with markings and colors so as to represent a first wild game species (e.g. a first fowl or bird species, a male or a female, etc.), while the bottom surface 50 of the decoy panel 12 can be adorned with different markings and colors so as to represent a second wild game species (e.g. a second fowl or bird species, the other one of the male or the female, etc.). Therefore, each surface 48, 50 can be adorned with different markings and colors so as to allow the decoy panel 12 to represent two particular bird or fowl species. Such configuration of the decoy panel 12 helps in reusing the same deployable decoy system 10 for different hunting (according to different species, different regions, different times of the year, etc.), or to put in place a more realistic sample of a plurality of wild game species so as to efficiently attract the selected wild game species.

In some implementations, the markings on the first and/or second surfaces 48, 50 are at least one of printed, painted, lithographed and silkscreen printed on the corresponding surface for the markings to be substantially realistic (i.e. substantially similar to the wild game species to be represented). In other words, the top and/or bottom surfaces 48, 50 can be molded, painted, textured (e.g. with feathers), disposed with an ornamental canvas, lined, dyed, silk screen sprayed, woven, coated, layered with ornamental media or picture, lithographed and the like, so as to provide the top and/or bottom surfaces 48, 50 with the desired appearance. The fact that the foldable decoy panel 12 is at least partially made of a substantially flat blank panel eases the use of different printing technologies enabling the substantially faithful reproduction of the desired wild game species.

In some implementations, the top surface 48 and/or the bottom surface 50 of the decoy panel 12 can be adorned with markings and colors so as to represent a wild game waterfowl species or a wild game fowl species. The wild game waterfowl species can include, without limitation, Canada geese, Snow geese, mallards, black ducks, mottled ducks, Mexican ducks, pintails, gadwalls, American pigeons, shovelers, wood ducks, green-winged teal, blue-winged teal, cinnamon teal, fulvous tree duck, black-bellied tree ducks, American coots, and the like. The wild game fowl species can include, without limitations, owls, wild turkey, pigeons, crows, and the like. A person skilled in the art to which the decoy system 10 pertains would understand that any animal can be represented (i.e., rabbit, jackrabbit, wild boar, and the like).

In some implementations, the decoy panel 12 can be at least partially made of, without limitations, a plastic, a rubber, a foam, a fabric, and the like. In some implementations, the decoy panel 12 can be made of a material which allows the decoy panel 12, and therefore the deployable decoy system 10, to be buoyant, to float. In other words, in the embodiment shown, the foldable decoy panel 12 is at least partially formed of a buoyant material. In some implementations, the material which allows the decoy panel 12 to be buoyant can include a polymer material. Such polymer material can include, without limitations, a plastic material, a rubber material, a polymeric material, a neoprene material, a closed-cell acrylonitrile butadiene rubber material, a polyethylene material, a polypropylene material, a polyurethane material, a foam material, a foam material comprising ethylene-vinyl acetate (EVA), a foam material comprising ethanolamine (ETA), a foam material provided with cells configured in opened or closed configurations, and the like. For instance, the foldable decoy panel 12 is at least partially formed in a resilient material allowing the foldable decoy panel 12 to be configured back into a substantially two-dimensional configuration. A person skilled in the art to which the deployable decoy system 10 pertains would however understand that the material used to form the decoy panel 12 can be any material that allows the decoy panel 12 to be substantially planar when in its two-dimensional configuration, that is configured to form the decoy hollow body 14 in the deployed three-dimensional configuration, and that takes back its initial substantially planar configuration when provided back in its two-dimensional configuration (i.e. when the assembling elongated member 30 is released).

In some implementations, the selected material can be lightweight, resilient, and/or provide buoyancy to the decoy panel 12. In some implementations, the selected material can have a memory (i.e. to be substantially resilient) so that the decoy panel 12 can be deployed between its two-dimensional configuration and its deployed three-dimensional configuration. For instance, one or more rods, for instance at least partially made of plastic, metal or any other suitable resilient material, can be provided and inserted into or mounted to a surface of the decoy panel (for instance substantially centrally into or onto one of the plurality of decoy extensions). In some implementations, the selected material can be impervious to weather conditions, to water, to extreme temperatures, and the like.

The deployable decoy system 10 described herein can therefore realistically and/or substantially faithfully represent a particular wild game species and can therefore attract or stimulate a particular wild game species, thanks to the three-dimensional configuration of the decoy panel 12 which provides a decoy hollow body 14 that substantially realistically represents a wild game body, and further, to the decoy three-dimensional head 26 which realistically represents a wild game head.

Again, the decoy hollow body 14 and/or the decoy three-dimensional head 26 can take any shape, size and/or configuration, as long as it realistically represents a wild game body or head. Therefore, a person skilled in the art to which the deployable decoy system 10 pertains would understand that, while wild waterfowl game species are illustrated in the figures, other wild fowl game species or wild game species (birds, mammals, etc.) can be represented by the decoy panel 12 forming the decoy hollow body 14, and the decoy three-dimensional head 26.

Still referring to the non-limitative embodiment of FIGS. 1 to 3, the decoy panel 12 can be deployed (i.e. configured) in its deployed three-dimensional configuration (FIGS. 1 and 3) so as to represent a wild game body and releasably secured in such configuration by pulling the assembling elongated member 30 which passes through (i.e. which is received within) the plurality of elongated member-receiving channels 24. In some implementations, the assembling elongated member can take the form of a rope, a cord (FIGS. 1 and 3), an elastic, and the like. Indeed, pulling the assembling elongated member 30 will force each one of the plurality of spaced apart decoy extensions 18 to interface with, or to come closed to, adjacent ones of the plurality of spaced apart decoy extensions 18, thereby forming the decoy hollow body 14.

It is appreciated that the shape and the configuration of the foldable decoy panel, as well as the shape, the configuration, the number and/or the relative arrangement of the decoy main section and the decoy extensions thereof can vary from the embodiment shown.

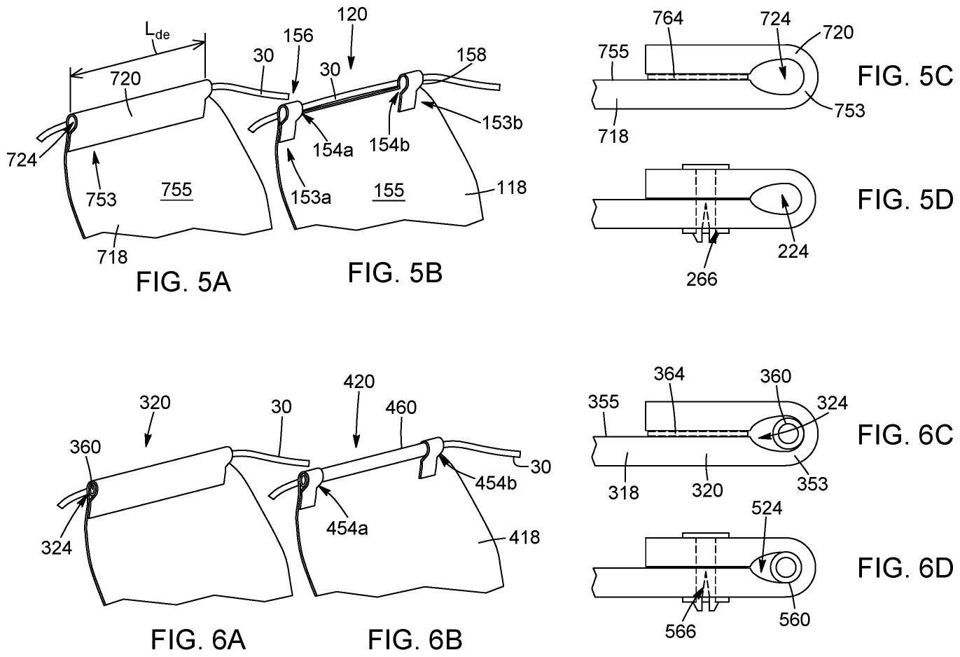

Now referring to the non-limitative embodiment of FIG. 5A, in some implementations, a single elongated member-receiving channel 724 can be formed at least partially along a length of the distal edge 720 so as to receive the assembling elongated member 30 (or at least a portion thereof) therein. As shown, the single elongated member-receiving channel 724 can be formed by folding up an end section 753 of the decoy extension 718 and by mounting it (for instance by securing it, for instance by glue or any other suitable mechanical fastener) to the extension surface 755 (or alternatively to the opposite extensions surface). In other words, the elongated member-receiving channel 724 is formed by folding up a portion of the distal edge 720 of the corresponding decoy extension 718.

In the embodiment shown, the distal edge 720 of the decoy extension 718 has a length Lde (corresponding substantially to the extension width We of the decoy extension); the elongated member-receiving channel 724 extends along substantially an entirety of the length Lde of the distal edge 720.

Now referring to the non-limitative embodiment of FIG. 5B, in some implementations, the elongated member-receiving channel can be made of at least two elongated member-receiving channel sections 154a, 154b being formed at opposed longitudinal end portions 156, 158 of the distal edge 120 of the foldable decoy extension 118 so as to receive the assembling elongated member 30 therein. The channel sections 154a, 154b can be formed by folding two end sections 153a, 153b of the decoy extension 118 and by mounting them (for instance securing them) to the extension surface 155 (or alternatively, to the opposite extension surface). In other words, the channel sections 154a, 154b of the elongated member-receiving channel 124 can be formed by folding up a portion of the distal edge 120 of the corresponding decoy extension 118.

FIG. 5C illustrates a cross-sectional view of the distal edge 720 of the decoy extension 718 of FIG. 5A described above and in accordance with a non-limitative embodiment. In some implementations, the end section 753 of the decoy extension 718 can be secured to the extension surface 755 using different chemicals and/or mechanical methods. As illustrated in the non-limitative embodiment of FIG. 5C, the end section 753 of the decoy extension 718 can be secured to the extension surface 755 by providing a layer 764 of an adhesive material (e.g. a layer of glue).

In accordance with another embodiment, as best shown in FIG. 5D, one or more rivet connectors 266 can be used to form the elongated member-receiving channel 224 (or to form a plurality of elongated member-receiving channel sections).

Other systems can be provided. For example, hook and loop fasteners can be used to form the channel(s). Same or different systems can be provided to secure the two end sections 153a, 153b of the decoy extension 118 in accordance with the embodiment represented in FIG. 5B.

Now referring to the non-limitative embodiment shown in FIG. 6A, in some implementations, a tube-like member 360 can be inserted into the formed elongated member-receiving channel 324 so as to receive the elongated attachment member or cord or assembling elongated member 30 (or at least a portion thereof). The tube-like member 360 is shaped and dimensioned to maintain in a substantially open configuration the elongated member-receiving channel 324, in order to ease the insertion and/or sliding of the assembling elongated member therein (i.e. to ease the folding of the foldable decoy panel into the deployed three-dimensional configuration).

Now referring to the non-limitative embodiment shown in FIG. 6B, the tube-like member 460 can be inserted into the two or more spaced apart elongated member-receiving channel sections 454a, 454b at the distal edge 420 of the foldable decoy extension 418 so as to receive the assembling elongated member or cord 30 (or at least a portion thereof) therein.

FIG. 6C illustrates a cross-sectional view of the distal edge 320 of the decoy extension 318 of FIG. 6A described above and in accordance with a non-limitative embodiment. In some implementations, the end section 353 (or the plurality of end sections) of the decoy extension 318 can be secured to the extension surface 355 using different chemicals and/or mechanical methods. As illustrated in the non-limitative embodiment of FIG. 6C, the end section 353 (or the plurality of end sections) of the decoy extension 318 can be secured to the extension surface 355 prior to receiving the tube-like member 360, by providing a layer 364 of an adhesive material (e.g. a layer of glue).

As shown in the non-limitative embodiment of FIG. 6D, one or more rivet connectors 566 can be used to form the channel 524 (or the plurality of channel sections) prior to receiving the tube-like member 560.

A person skilled in the art to which deployable decoy system 10 pertains would understand that tube-like member 360, 460 can be strongly secured or releasably secured to the internal surface(s) defining the elongated member-receiving channel 324 or the plurality of elongated member-receiving channel sections 354a, 354b.

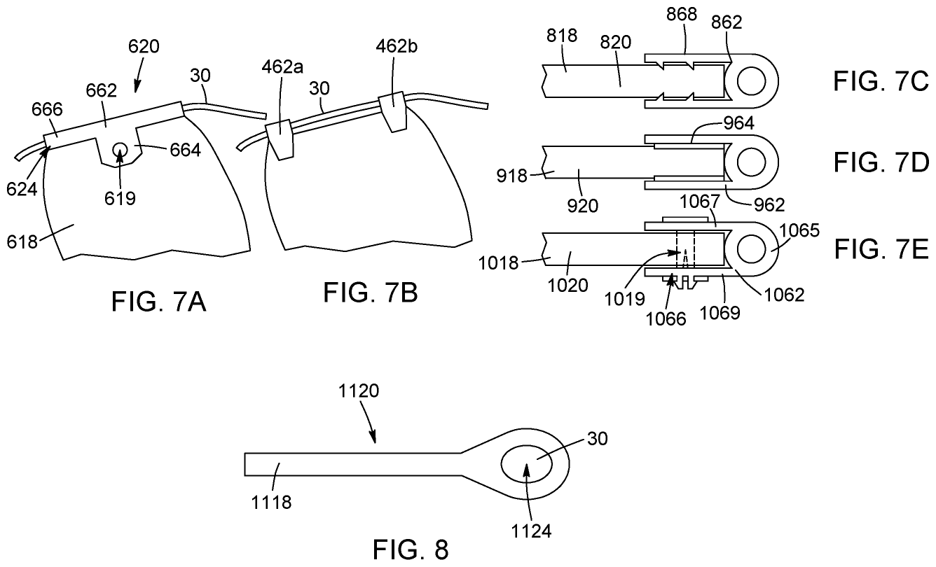

Now referring to the non-limitative embodiment shown in FIG. 7A, in some implementations, an elongated member-receiving clip 662 with a single elongated member-receiving channel 624 being formed therein can be secured to the decoy extension 618 (for instance to the distal edge 620 thereof) (i.e. mounted to a clip-receiving aperture 619 formed in the distal edge 620 of the decoy extension 618) so as to receive the assembling elongated member 30 therein. In other words, the elongated member-receiving clip 662 comprises a panel-mounting end portion 664 mounted to the distal edge of the decoy extension 618 and a distal end portion 666 forming (i.e. at least partially delimiting) the elongated member-receiving channel 624.

Now referring to the non-limitative embodiment shown in FIG. 7B which represents the distal edge 20 of one of the decoy extensions 18 of the foldable decoy panel 12 of FIGS. 1 to 3, in some other implementations, a plurality of elongated member-receiving clips 62a, 62b, each elongated member-receiving clip having an elongated member-receiving channel section 54a, 54b being formed therein, can be secured to the decoy extension 18 (for instance to the distal edge 20 thereof) (i.e. mounted to a clip-receiving aperture formed 19 in the distal edge 20 of the decoy extension 18) so as to receive the assembling elongated member 30 therein.

Now referring to the non-limitative embodiment of FIG. 7C, in some implementations, the elongated member-receiving clip 862 (or the plurality of elongated member-receiving clips) can be provided with one or more hooks 868 so as to be mounted (for instance secured) to the distal edge 820 of the decoy extension 818.

In some implementations, as best shown in FIG. 7D, the elongated member-receiving clip 962 (or the plurality of elongated member-receiving clips) can be mounted (for instance secured) to the distal edge 920 of the decoy extension 918 using a layer 964 of an adhesive material (e.g. a layer of glue).

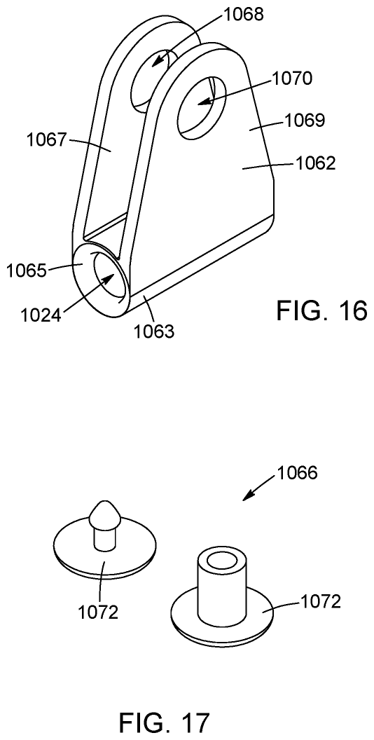

In some other implementations, as best shown in FIGS. 7E, 16 and 17, the elongated member-receiving clip 1062 (or the plurality of elongated member-receiving clips) can be secured to the distal edge 1020 of the decoy extension 1018 via one or more panel-mounting rivet 1066. For instance, in the embodiment shown, the elongated member-receiving clip 1062 comprises a clip body 1063 in which is formed the elongated member-receiving channel 1024. For instance, the clip body 1063 comprises a channel-forming member 1065 having a substantially cylindrical shape and delimiting at least partially the elongated member-receiving channel 1024, and first and second panel-mounting wings 1067, 1069 extending substantially parallel to each other, spaced apart from each other, and mounted to the channel-forming member 1065. Rivet-receiving openings 1068, 1070 are formed in the first and second panel-mounting wings 1067, 1069, in register with each other.

In the embodiment shown, the panel-mounting rivet 1066 comprises a female member 1072 and a male member 1074 securable to each other and engageable with the rivet-receiving openings 1068, 1070 formed in the first and second panel-mounting wings 1067, 1069 and with a corresponding clip-receiving aperture 1019 formed in the distal edge 1020 of the decoy extension 1018 to secure the clip body 1063 to the decoy extension at the distal edge thereof. It is appreciated that the shape and the configuration of the elongated member-receiving clip 1062, as well as the shape, the configuration and/or the relative arrangement of the clip body and the panel-mounting rivet can vary from the embodiment shown. For instance, even though in the embodiment shown, the panel-mounting rivet and the clip body are distinct members, it could also be conceived an embodiment wherein the panel-mounting rivet would at least partially be formed integral with the clip body (for instance with the female and male members being formed integral with a corresponding one of the first and second panel-mounting wings).

A person skilled in the art to which deployable decoy system 10 pertains would however understand that the one or more elongated member-receiving clips in accordance with any one of the above-described embodiments can be fixedly or releasably secured to the decoy extension using different chemicals and/or mechanical methods. For example, hook and loop fasteners, clips, staples, matching connectors, tabs and slits, and the like, can be used. In some implementations, the one or more elongated member-receiving clips can be made of a polymeric material, or alternatively, of a metallic material.

It is thus understood that the elongated member-receiving channel and/or the elongated member-receiving channel sections are shaped and dimensioned to prevent adjacent decoy extensions from getting one over the other (i.e. from getting at least partially superposed) once the assembling elongated member is being pulled. Indeed, an end portion of the distal edge of a decoy extension will interface with an end portion of the distal edge of an adjacent decoy extension. The tube-like member 60, 160, 360, 460 can further provide an additional structural rigidity to the elongated member-receiving channel or the plurality of elongated member-receiving channel sections, and also help in preventing adjacent decoy extensions from getting one over the other (i.e. from getting at least partially superposed) once the assembling elongated member is being pulled. As mentioned, the elongated member-receiving channel sections can be positioned at end portions of the panel extension (for instance at end portions of the distal edge 20 thereof) such that an outward end portion of the elongated member-receiving channel section of a decoy extension can be aligned with an outward end portion of the elongated member-receiving channel section of an adjacent decoy extension once the foldable decoy panel 12 has been configured in its deploy three-dimensional configuration (FIGS. 1 and 3). A person skilled in the art would understand that one single elongated member-receiving channel or alternatively, a plurality of elongated member-receiving channel sections can be found at the distal edge of a decoy extension. The assembling elongated member 30 can therefore be at least partially covered, as illustrated in FIGS. 5A, 6A, 6B, 7A, or at least partially accessible, as illustrated in FIGS. 5B and 7B.

It is appreciated that the shape, the configuration, and the location of the elongated member-receiving channel can vary from the embodiments shown. For instance, as best shown in FIG. 8, the elongated member-receiving channel 1124 could be formed directly within the distal edge 1120 of the decoy extension 1118 to receive at least portion of the assembling elongated member 30. The features of the different embodiments of the above-described elongated member-receiving channels could also be combined together.

Now referring more particularly to the non-limitative embodiment of FIGS. 1 and 3, in some implementations, the assembling elongated member 30 can define a first attachment end 70 and a second attachment end 72 opposite the first attachment end 70. It is understood that the assembling elongated member is insertable in the plurality of elongated member-receiving channels 24 mounted to or part of the decoy extensions (for instance of the distal edges thereof). In some implementations, the assembling elongated member 30 can alternatively define a closed loop. In some implementations, the first and second attachment ends 70, 72 can be secured to a locking fastener 74 which will provide the foldable decoy panel 12 to remain in its deployed three-dimensional configuration once the assembling elongated member or cord 30 has been pulled (i.e. configured to block the foldable decoy panel in the deployed three-dimensional configuration). A person skilled in the art would understand that other suitable mechanisms (or mechanical fasteners) could be used to secure the decoy panel 12 in position, with the cord 30 being pulled. A simple knot can also be provided, for example.

Sufficient length of the assembling elongated member 30 needs to be provided so it can pass through (i.e. so it can be received within) the elongated member-receiving channels 24 or the plurality of elongated member-receiving channel sections when the decoy panel 12 is configured into the two-dimensional configuration (i.e. configured into the undeployed configuration or relaxed configuration or transport configuration).

Now referring to the non-limitative embodiments of FIGS. 1 and 9 to 12, and as mentioned above, the deployable decoy system 10 further includes a decoy three-dimensional head 26, 126, 226, 326, 426 (or a plurality of interchangeable decoy three-dimensional heads 26, 126, 226, 326, 426), which is mountable (for instance securable) to the decoy hollow body (for instance via the head-mounting aperture 22 formed in the decoy panel 12). In some implementations, the decoy three-dimensional head can be releasably mountable (for instance securable) to the decoy panel 12.

As illustrated in FIG. 10, the decoy three-dimensional head 226 includes a neck portion 276 as well as a head portion 278, which extends from an upper end of the neck portion 276. In some implementations, the decoy three-dimensional head 226 can be adorned with markings and colors so as to represent a specific wild game species (i.e. has an outer surface 227 with markings thereon). In some implementations, the decoy three-dimensional head 226 can be painted, textured (e.g., feathers), disposed with an ornamental canvas, lined, dyed, silk screen sprayed, woven, coated, layered with ornamental media or picture, lithographed, silkscreen printed and the like, for instance on the outer surface 227 thereof, so as to provide the decoy three-dimensional head 226 with the desired appearance.

In some implementations, the decoy three-dimensional head 226 can be adorned with markings and colors so as to represent a wild game waterfowl species or a wild game fowl species. The wild game waterfowl species can include, without limitation, Canada geese, Snow geese, mallards, black ducks, mottled ducks, Mexican ducks, pintails, gadwalls, American pigeons, shovelers, wood ducks, green-winged teal, blue-winged teal, cinnamon teal, fulvous tree duck, black-bellied tree ducks, American coots, and the like. The wild game fowl species can include, without limitations, owls, wild turkey, pigeons, crows, and the like.

In some implementations, the deployable decoy system 10 can further include a plurality of interchangeable head covers (e.g. balaclava) configured to cover the decoy three-dimensional head 226 (neck and/or head portions 276, 278 thereof). In some implementations, the interchangeable head covers can be adorned with markings and/or colors, so as to represent different wild game species. In some implementations, the material can be flexible, extensible, lightweight, and/or impervious to weather conditions, to water, to extreme temperatures, and the like. In some implementations, the material can include a fabric material. In some implementations, the fabric material can include nylon, plastic, rubber, polyester, polyethylene, polypropylene, polyurethane, ETA foam or EVA foam in a closed cell configuration or in an opened cell configuration, and the like. In some implementations, the fabric material can include synthetic fibers, natural fibers, synthetic films, natural films and the like.

In some implementations (FIG. 12), the decoy three-dimensional head 126 can be static (i.e., no movement of the head portion 178 relatively to the neck portion 176 or to the decoy hollow body when mounted thereto).

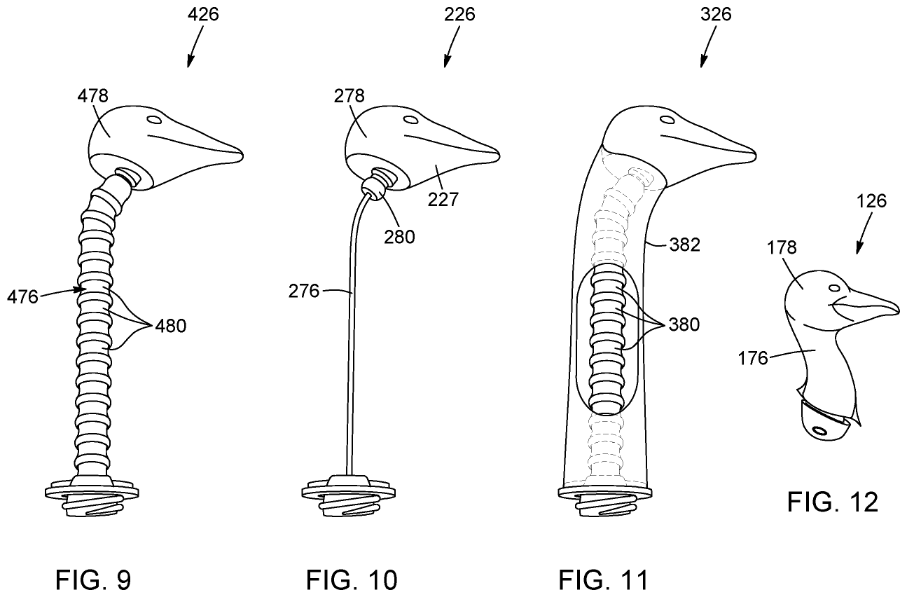

In some implementations, the head portion 278, 378, 478 of the decoy three-dimensional head 226, 326, 426 can move relatively to the formed decoy hollow body when mounted thereto. In some implementations (FIG. 9), the neck portion 476 can include a plurality of neck articulated joints 480 which are movable (i.e. pivotable) one relatively to the other. In some implementations, the neck articulated joints can take the form of, without limitations, hinge, ball-and-socket, wire 280 (FIG. 10), spring swivel, hook and the like. In some implementations (FIG. 11), the neck articulated joints 380 can be enclosed in a neck covering member 382, which can be made of, without limitation, plastic, rubber, neoprene, closed-cell acrylonitrile butadiene, rubber foam, polyethylene, polypropylene, polyurethane foam, ETA foam or EVA foam in a closed cell configuration or opened cell configuration, and the like. The material can be lightweight, resilient, and/or impervious to weather conditions, water, extreme temperatures, and the like. The neck covering member 382 (for instance an outer surface thereof) can be contoured in various ways, painted, textured (e.g., feathers), disposed with an ornamental canvas, lined, dyed, painted, silk screen sprayed, woven, coated, layered with ornamental media, lithographed, silkscreen printed and the like to provide the desired appearance.

In some implementations, the head portion can be releasably secured to the neck portion. The releasable connection can be provided by any suitable mechanism, as would be known by a person skilled in the art (e.g., tab and slit, tongue-and-dado, hook and loop fasteners, clip, matching connectors, magnetic connectors, screw type connectors, and the like).

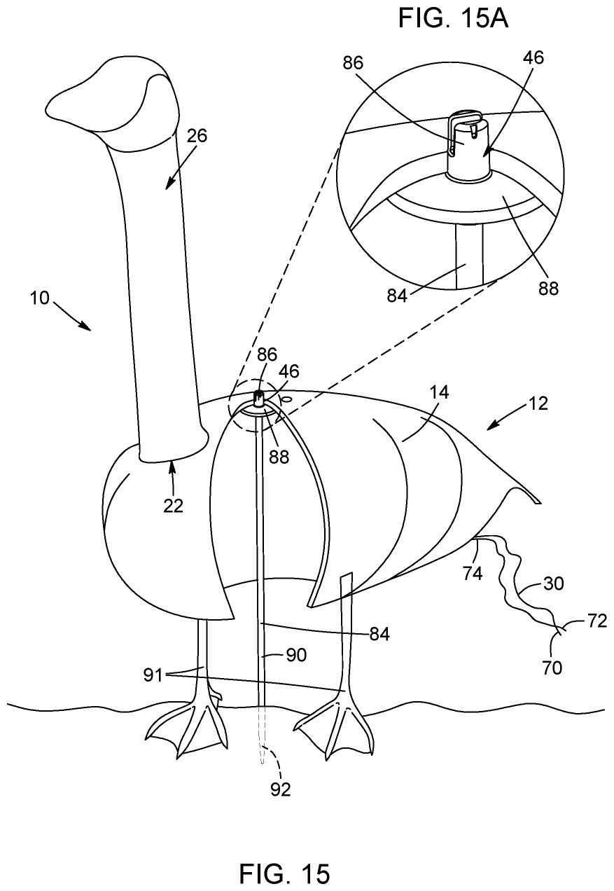

As best shown in FIGS. 1 and 15, in some implementations, the deployable decoy system 10 can include an anchoring member 84 which is releasably secured to the decoy hollow body 14 via the stake-mounting aperture 46 (or ground-mounting aperture 46). Accordingly, the decoy system 10 can be placed or positioned on land or on a field. As shown, the deployable decoy system 10 is anchored to the ground by the anchoring member 84. In some implementations, the anchoring member 84 includes a grommet 86 (or body-engaging end portion 86) which is configured to be insertable into the stake-mounting aperture 46 (or ground-mounting aperture 46) (i.e. which is engageable with the decoy panel). In some implementations, the grommet 86 includes an aperture formed therein and configured to secure the anchoring member 84 to the decoy hollow body 14. The anchoring member 84 further includes an enlarged portion 88 downwardly extending from the grommet 86 as well as a stake 90, which extends downwardly from the enlarged portion 88. The enlarged portion 88 supports at least partially the decoy panel 12 when the body-engaging end portion 86 is engaged with the decoy panel 12. The stake 90 defines a sharpened lower end 92 (or sharpened ground-engaging end 92), which is engageable with the ground surface.

By applying a downward pressure or force to the enlarged portion 88 of the anchoring member 84 (using a user's foot for example), the stake 90 can be secured into the ground, or mud for example, so as to support the decoy system 10 in an anchored manner over the ground. In some implementations, the stake 90 can define any length, so as to accommodate various terrains of grounds and fields where decoy systems 10 will be placed. The decoy systems 10 can therefore be positioned on the ground or alternatively, over the ground. Providing a deployed decoy system 10 over the ground allows the user to secure decoy legs 91 (FIG. 15) to the hollow decoy body 14 and to position them as required. Securing decoy legs 91 and/or decoy wings to the decoy hollow body 14 helps in realistically representing the wild game. Such realistic representation can effectively attract wild game species.

In some implementations, the deployable decoy system 10 can further include a stabilizer device, or alternatively, a plurality of stabilizer devices, which can act as a ballast or stabilizer, once the system is provided as a buoyant system into water. The stabilizer device can include a connecting link, which can be secured to the decoy hollow body, and a weight, which extends from the connecting link. The stabilizer device, and more particularly the weight, can be configured so as to maintain the deployed decoy system 10 in a floating, upright position into a body of water.

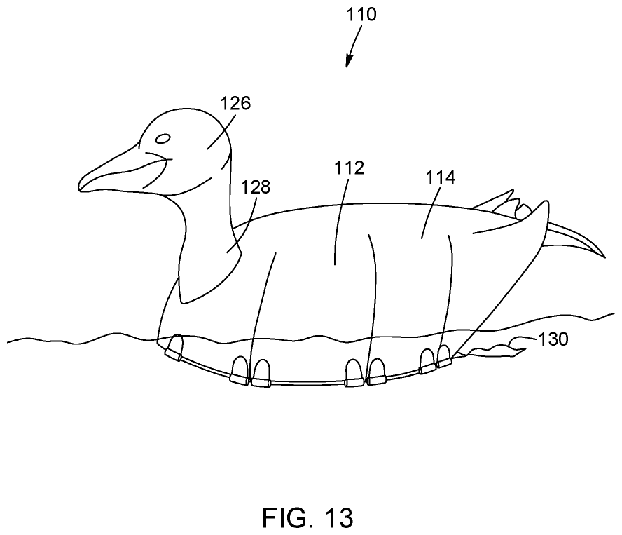

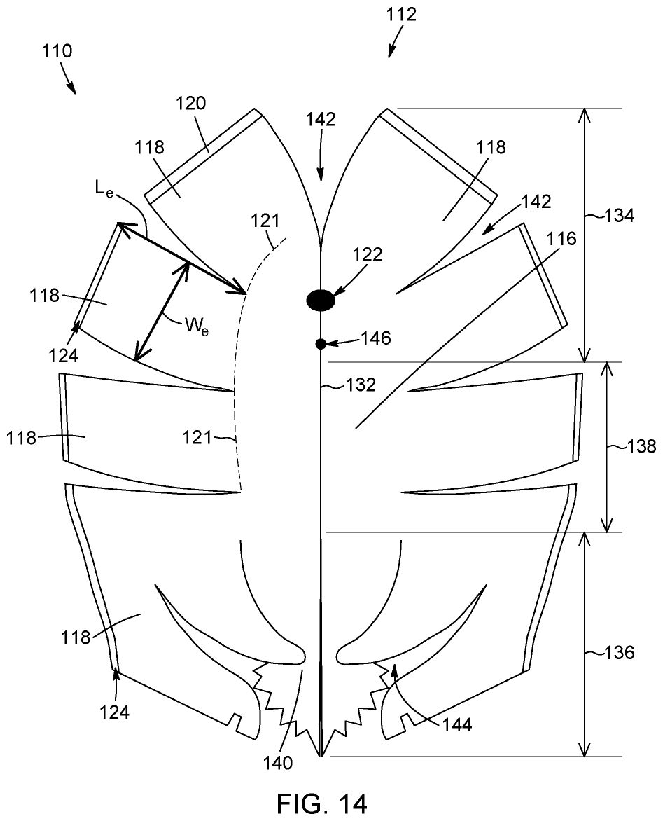

Now referring more particularly to the non-limitative embodiment of FIGS. 13 and 14, there is provided a deployable decoy system 110 in accordance with another embodiment. According to this embodiment, a decoy hollow body 114 is formed, being about half the formed decoy hollow body 14 of the first embodiment. The decoy system 110, once deployed, can be used for instance onto water or in field. Similarly to the first embodiment, the deployable decoy system 110 includes a foldable decoy panel 112 comprising a decoy main section 116; and a plurality of decoy extensions 118 extending from the decoy main section, each of the plurality of decoy extensions comprising a proximal edge 121 being part of or being mounted to the decoy main section and a distal edge 120 extending in a spaced relationship to the proximal edge, each decoy extension being foldable with respect to the decoy main section 116 to configure the decoy panel in the deployed three-dimensional configuration (FIG. 13) forming a decoy hollow body 114 representing a wild game body. The decoy panel 112 is also configurable into the two-dimensional configuration (FIG. 14). The decoy panel 112 includes the decoy main section 116, or decoy substantially central section 116, as well as the plurality of spaced apart decoy extensions 118 (or peripheral flaps 118) which extend away from the decoy main section 116. The decoy panel 112 further includes a head mounting aperture 122 which is formed in the decoy main section 116. The deployable decoy system 110 further comprises a plurality of elongated member-receiving channels 124 (or string-receiving channels), as described above, which are mounted to or part of the decoy extensions 118 (for instance mounted to or part of the distal edges 120 thereof).

In the embodiment shown, at least one of the plurality of decoy extensions 118 has an extension length Le extending between the proximal and distal edges 121, 120, and an extension width We, the extension width We being smaller than or substantially equal to the extension length Le.

Still referring to the non-limitative embodiment of FIGS. 13 and 14, the deployable decoy system 110 further includes the decoy three-dimensional head 126 which represents a wild game head. Any other one of the above-described decoy three-dimensional heads could be mounted to the foldable decoy panel 112.

The decoy three-dimensional head 126 defines a securing end 128 (body-mounting end 128), which is mountable (for instance securable) to the head mounting aperture 122 formed in the decoy panel 112. The deployable decoy system 110 further includes an elongated attachment member (not shown), which is configured to be inserted in the plurality of elongated member-receiving channels 124. The elongated attachment member is configured to be pulled so as to force each decoy extension 118 to interface with, or to be brought closed to, its adjacent decoy extensions 118, thereby forming the decoy hollow body 114 shown in FIG. 13.

Referring now more particularly to FIG. 14, in some implementations, the decoy panel 112 includes eight spaced apart decoy extensions 118, or sleeves 118, wherein each decoy extension 118 extends from a centered line 132 defined by the decoy main section 116. The decoy panel 112 extends between an anterior section 134 and a posterior section 136 which includes a tail portion 140. A central section 138 further separates the anterior section 134 from the posterior section 136. As illustrated in the non-limitative embodiment of FIG. 14, two adjacent decoy extensions 118 are spaced apart from each other by a V-shaped void 142. However, in the posterior section 136, the decoy extensions 118 that are adjacent to the tail portion 140 are spaced apart from the tail portion 140 by an irregular shaped void 144. A person skilled in the art to which deployable decoy system 110 pertains would however understand that the decoy panel 112 can take any shape, size and/or configurations so as to form a decoy hollow body 114 which would represent the body of a specific wild game. Moreover, the person skilled in the art would easily combine features of the above-described embodiments of the deployable decoy system 10, 110.

Because of its configuration (i.e. its shape, dimensions and/or material), the decoy hollow body 114 can float more efficiently onto water surface.

Still referring to the non-limitative embodiment of FIG. 14, the head mounting aperture 122 is provided in the anterior section 134 of the decoy main section 116. Furthermore, the tail portion 140 is longitudinally aligned with the head mounting aperture 122 (i.e. both the head mounting aperture 122 and the tail portion 140 are provided about the centered line 132).

Still referring to the non-limitative embodiment of FIGS. 13 and 14, the decoy panel 112 can further include a stake-mounting aperture 146 formed in the decoy main section 116. Such aperture can further be used to secure the stabilizer device described above. In some implementations, the foldable decoy panel 112 can further include wing mounting apertures (not shown) and/or leg mounting apertures (not shown) for securing wings and/or legs which represent wild game wings and/or legs.

As mentioned above, the decoy panel 112 is deployable, or foldable, between the two-dimensional configuration shown in FIG. 14 and the deployed three-dimensional configuration shown in FIG. 13, so as to form the decoy hollow body 114. The deployed three-dimensional configuration can therefore represent a body of a particular wild game species. In some implementations and as well illustrated in FIGS. 13 and 14, the decoy panel 112 provided in its deployed three-dimensional configuration can realistically represent a particular wild waterfowl game species.

Therefore, in operation, so as to provide the decoy panel 12, 112 in its deployed three-dimensional configuration, both ends of the assembling elongated member 30 (or two sections of the attachment member in the alternative of a closed loop) are being pulled, forcing each decoy extension 18, 118 to interface with, or to be brought close to, an adjacent or adjacent decoy extensions 18, 118, so as to form the decoy hollow body 14, 114 which realistically represents a wild game body, such as a wild fowl game body or wild waterfowl game body. Thanks to the configuration of the elongated member-receiving channels 24, 124 or elongated member-receiving channel sections 54a, 54b, 154a, 154b, adjacent decoy extensions 18, 118 can interface or touch, but not overlap with adjacent decoy extensions while the assembling elongated member 30 or cord is being pulled. When configured in the deployed three-dimensional configuration, the foldable decoy panel 12, 112 forms a decoy hollow body 14, 114. A decoy three-dimensional head 26, 126 can further be releasably mounted to (for instance secured to) the decoy hollow body 14, 114 via the head-mounting aperture 22, 122. In some implementations, one of the plurality of interchangeable head covers can further be selected and provided on the decoy three-dimensional head 26, 126.

In some implementations, where the decoy system 10, 110 needs to be provided in a field for example, the anchoring member 84 can further be releasably secured to the decoy hollow body 14, 114 via stake mounting aperture 46, 146. A stabilizer device can also be secured to the decoy hollow body 14, 114, for instance when the decoy hollow body 14, 114 is provided into a body of water.

However, when the decoy three-dimensional head 26, 126, the anchoring member 84, the legs, the wings, the head cover, and the like have been removed or released from the decoy hollow body 14, 114, and when the elongated attachment member 30, 130 is being released (e.g., from the locking fastener 74), the resilient material forming the decoy panel 12, 112 allows it to regain its substantially planar two-dimensional configuration. The deployable decoy system 10, 110 is thus easily storable and/or transportable. A plurality of decoy panels 12, 112 can therefore be quickly, easily, and efficiently stacked one over the other for facilitating storage, transport and reinstallation on a different site.

The present disclosure thus also concerns a decoy kit for forming at least one deployable decoy system, the kit comprising at least one foldable decoy panel according to the present disclosure, and one or more interchangeable decoy three-dimensional heads mountable to at least one of foldable decoy panel.

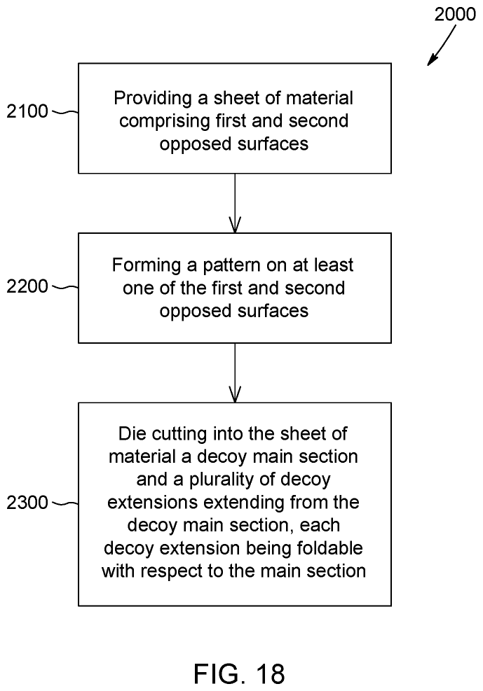

According to another aspect of the disclosure, as represented in the block diagram of FIG. 18, there is provided a method 2000 for manufacturing a foldable decoy panel.

The method 2000 comprises a step 2100 of providing a sheet of material comprising first and second opposed surfaces; a step 2200 of forming a pattern (comprising for instance a plurality of marks) on at least one of the first and second opposed surfaces; and a step 2300 of die cutting into the sheet of material a decoy main section and a plurality of decoy extensions extending from the decoy main section, each decoy extension being foldable with respect to the main section.

In the embodiment shown, the step 2200 of forming the pattern on the at least one of the first and second opposed surfaces comprises at least one of printing, painting, lithographing and silkscreen printing the pattern.

In the embodiment shown, the step 2200 of forming the pattern comprises at least one of texturing, arranging an ornamental canvas, lining, dying, weaving, coating and layering with ornamental media at least one of the first and second surfaces.

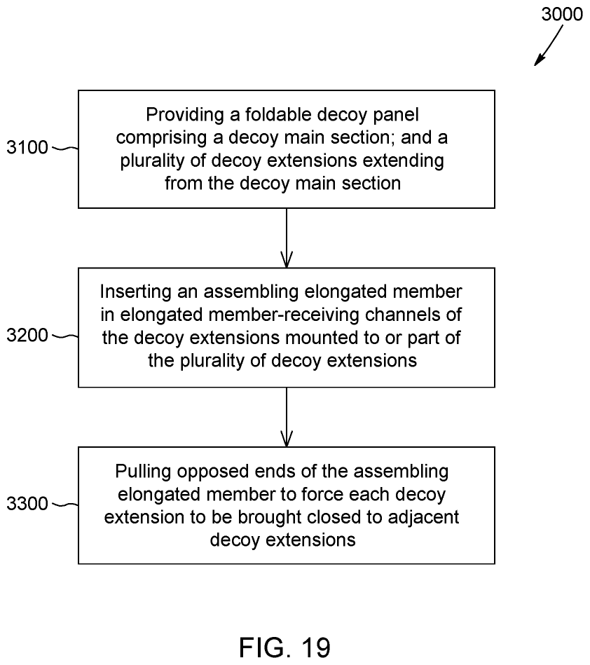

According to another aspect of the disclosure, as represented in the block diagram of FIG. 19, there is provided a method 3000 for deploying a decoy system for the attraction of wild game. The method according to embodiments of the present disclosure may be carried out with a deployable decoy system 10, 100 such as those described above.

In the embodiment shown, the method 3000 comprises a step 3100 of providing a foldable decoy panel comprising a decoy main section; and a plurality of decoy extensions extending from the decoy main section, each of said plurality of decoy extensions comprising a proximal edge being part of or being mounted to the decoy main section and a distal edge extending in a spaced relationship to the proximal edge, a plurality of elongated member-receiving channels being mounted to or part of the plurality of decoy extensions (for instance being mounted to or part of the distal edges thereof); a step 3200 of inserting an assembling elongated member in the elongated member-receiving channels of the decoy extensions; and a step 3300 of pulling opposed ends of the assembling elongated member to force each decoy extension to be brought closed to adjacent decoy extensions.

In the embodiment shown, the method 3000 further comprises a step of securing at least one of a decoy three-dimensional head and anchoring members to the decoy panel.

The final deployed decoy systems described above can realistically represent a plurality of wild game species. In some implementations, the decoy system can further include a speaker through which recorded, or broadcast sound, can be heard. Indeed, the systems described provide three-dimensional realistic body and head configurations. The three-dimensional decoy head can also be articulated or interchangeable, thanks to the head cover, which gives the hunter many choices in the preparation of his/her site. Thus, a hunter can deploy a plurality of different wild game species (different in their positionings, markings, colors, etc.) on site, so as to represent a realistic sample of the wild game species. The described deployable decoy systems are also easy to deploy and resistant once on field or into water.

Although the present invention has been described hereinabove by way of specific embodiments thereof, it can be modified, without departing from the spirit and nature of the subject invention defined in the appended claims.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1.-60. (canceled)

61. A foldable decoy panel for a deployable decoy system for the attraction of wild game, the foldable decoy panel comprising:
A decoy main section; and
A plurality of decoy extensions extending from the decoy main section, each of said plurality of decoy extensions comprising a proximal edge being part of or being mounted to the decoy main section and a distal edge extending in a spaced relationship to the proximal edge, each of said plurality of decoy extensions being foldable with respect to the decoy main section to configure the decoy panel in a deployed three-dimensional configuration forming a decoy hollow body representing a wild game body.

62. The foldable decoy panel according to claim 61, wherein the decoy panel extends between an anterior section and a posterior section and has a plane of symmetry extending between said anterior and posterior sections and defining a centered line of the decoy main section, wherein a head-mounting aperture is formed in the decoy main section, the centered line intersecting said head-mounting aperture and wherein at least one stake-mounting aperture is formed in the decoy main section in alignment with the centered line.

63. The foldable decoy panel according to claim 61, wherein the decoy panel comprises first and second opposed surfaces, the first and second surfaces comprise different markings thereon, wherein the at least one marking is at least one of printed, painted, lithographed and silkscreen printed.

64. The foldable decoy panel according to claim 61, wherein the distal edge of at least one of the plurality of decoy extensions comprises at least one clip-receiving aperture formed therein.

65. The foldable decoy panel according to claim 1, further comprising a plurality of elongated member-receiving channels mounted to or part of the plurality of decoy extensions, an assembling elongated member being insertable in the plurality of elongated member-receiving channels to configure the decoy panel in the deployed three-dimensional configuration upon pulling of the assembling elongated member.

66. The foldable decoy panel according to claim 65, wherein at least one of the plurality of elongated member-receiving channels is formed by folding up a portion of the distal edge of the corresponding one of the plurality of decoy extensions.

67. The foldable decoy panel according to claim 65, wherein at least one of the plurality of elongated member-receiving channels comprises at least two spaced-apart elongated member-receiving channel sections mounted to or part of one of the distal edge of the corresponding one of the plurality of decoy extensions, further comprising a tube-like member extending into said two spaced-apart elongated member-receiving channel sections.

68. A foldable decoy panel that is adapted to be folded to form a wild game body of a deployable decoy system, the foldable decoy panel comprising:
A central portion; and
A plurality of peripheral flaps pivotally mounted to the central portion and pivotable about fold lines acting as hinges to configure the decoy panel in a deployed three-dimensional configuration forming a decoy hollow body representing the wild game body.

69. The foldable decoy panel according to claim 68, wherein the decoy panel extends between an anterior section and a posterior section and has a plane of symmetry extending between said anterior and posterior sections and defining a centered line of the central portion, wherein a head-mounting aperture is formed in the central portion, the centered line intersecting said head-mounting aperture and wherein the head-mounting aperture is formed in the anterior section of the decoy panel.

70. The foldable decoy panel according to claim 68, wherein the decoy panel comprises first and second opposed surfaces, at least one of the first and second surfaces comprising at least one marking thereon, wherein the at least one marking is at least one of printed, painted, lithographed and silkscreen printed.

71. The foldable decoy panel according to claim 68, wherein at least one of the plurality of peripheral flaps has a flap length defined between the fold line and a distal edge of said at least one of the plurality of peripheral flaps, and a flap width, the flap width being smaller than or equal to the flap length and wherein the distal edge of at least one of the plurality of peripheral flaps comprises at least one clip-receiving aperture formed therein.

72. The foldable decoy panel according to claim 68, wherein at least one of the plurality of peripheral flaps has a flap length defined between the fold line and a distal edge of said at least one of the plurality of peripheral flaps, and a flap width, the flap width being smaller than or equal to the flap length, the foldable decoy panel further comprising a plurality of elongated member-receiving channels mounted to or part of the plurality of peripheral flaps, an assembling elongated member being insertable in the plurality of elongated member-receiving channels to configure the decoy panel in the deployed three-dimensional configuration upon pulling of the assembling elongated member, wherein at least one of the distal edges has a length, the corresponding one of the plurality of elongated member-receiving channels being mounted to or part of the distal edge and extending along substantially an entirety of the length thereof.

73. The foldable decoy panel according to claim 72, wherein at least one of the plurality of elongated member-receiving channels is formed by folding up a portion of the distal edge of the corresponding one of the plurality of peripheral flaps or further comprising at least one tube-like member extending within at least one of the plurality of elongated member-receiving channels.

74. A deployable decoy system, comprising
A foldable decoy panel according to claim 61; and
A plurality of elongated member-receiving clips, each of said plurality of elongated member-receiving clips comprising a panel-mounting end portion mounted to a corresponding one of the plurality of decoy extensions and a distal end portion forming an elongated member-receiving channel.

75. The deployable decoy system according to claim 74, further comprising at least one tube-like member extending within at least one of the plurality of elongated member-receiving channels, wherein at least one of the plurality of elongated member-receiving channels comprises two spaced-apart elongated member-receiving channel sections, said at least one tube-like member extending into said two spaced-apart elongated member-receiving channel sections.

76. The deployable decoy system according to claim 74, further comprising an assembling elongated member insertable in the plurality of elongated member-receiving channels.

77. The deployable decoy system according to claim 74, further comprising one or more anchoring members secured to the decoy hollow body, wherein said one or more anchoring members comprises a body-engaging end portion engageable with the decoy panel, and an enlarged portion supporting at least partially the decoy panel when the body-engaging end portion is engaged with the decoy panel.

78. The deployable decoy system according to claim 74, further comprising at least one decoy three-dimensional head mountable to the decoy hollow body, wherein said at least one decoy three-dimensional head comprises a body-mounting end.

79. A decoy kit for forming at least one deployable decoy system, the kit comprising:
At least one foldable decoy panel according to claim 61; and
One or more interchangeable decoy three-dimensional heads mountable to said at least one of foldable decoy panel.

80. A method for deploying a decoy system for the attraction of wild game, the method comprising:
Providing a foldable decoy panel according to claim 65;
Inserting an assembling elongated member in the plurality of elongated member-receiving channels; and
Pulling opposed ends of the assembling elongated member to force each of said plurality of decoy extensions to be brought closed to adjacent decoy extensions.
